(19) United States
(12) Patent Application Publication
(10) Pub. No.: US 2022/0029831 A1
(43) Pub. Date: Jan. 27, 2022

(54) DEVICE TO DEVICE AUTHENTICATION METHOD USING BLOCKCHAIN

(71) Applicant: LG ELECTRONICS INC., Seoul (KR)

(72) Inventors: Sunhee BAEK, Seoul (KR); Byungjoo LEE, Seoul (KR); Hyunsik YANG, Seoul (KR)

(73) Assignee: LG ELECTRONICS INC., Seoul (KR)

(21) Appl. No.: 17/245,657

(22) Filed: Apr. 30, 2021

(30) Foreign Application Priority Data
Mar. 5, 2020 (KR) 1020200028001

(51) Int. Cl. H04L 9/32; G16Y 10/75; G16Y 30/10

(52) U.S. Cl. CPC H04L 9/3268; H04L 2209/38; G16Y 30/10; G16Y 10/75

(57) ABSTRACT

An Internet of Things (IoT) device may transmit, to a Blockchain Node, a registration request signal including a public key certificate of the IoT device and a universally unique identifier (UUID) of the IoT device. The IoT device may receive, from the Blockchain Node, a first certification identifier (ID) for the IoT device, wherein the first Certification ID is a newly generated block. The IoT device may receive a first encrypted signal from an onboarding tool (OBT), wherein the encrypted signal includes a second certification ID of the OBT and encrypted information being encrypted based on a private key of the OBT. And, the IoT device may transmit, to the Blockchain Node, a verification request signal including the second certification ID of the OBT.

### CROSS-REFERENCE TO RELATED APPLICATIONS

Pursuant to 35 U.S.C. § 119 (e), this application claims the benefit of earlier filing date and right of priority to Korean Patent Application No. 10-2020-0028001, filed on Mar. 5, 2020, the contents of which are all hereby incorporated by reference herein in their entirety.

### TECHNICAL FIELD

The present specification relates to a device to device (D2D) authentication method using blockchain.

### BACKGROUND

The Open Connectivity Foundation (OCF) is an industrial connectivity standards organization for Internet of Things (IoT) that provides, as its specification standard, a common service framework that can be flexibly equipped (or loaded) to various form factors, operating systems, and wires/wireless connection technologies. An OCF framework is an Application Protocol Framework that operates on an abstracted wired/wireless connection technology, which is provided from each device prior to its abstraction. Herein, the OCF framework provides functions of Discovery that discovers devices, Data Transmission that exchanges information among the discovered devices, Data Management that manages secured device information or that is needed for creating an application service, which is configured by combining the secured device information, and Device Management that monitors device status and that controls and manages the devices when needed. All of the functions provided from the framework are defined as resource models, and security, identification, access management functions, and so on, that are needed in each function are horizontally defined. Extensive development is being made in order to provide various IoT services (Profiles), such as smart home, healthcare, distribution (goods), automotive, and so on, on the framework, which is configured as described above.

### SUMMARY

According to various embodiments, an Internet of Things (IoT) device may transmit, to a blockchain node, a registration request signal including a public key certificate of the IoT device and a universally unique identifier (UUID) of the IoT device. The IoT device may receive, from the blockchain node, a first certification identifier (ID) for the IoT device, wherein the first certification ID may be a newly generated block. The IoT device may receive a first encrypted signal from an onboarding tool (OBT), wherein the encrypted signal may include a second certification ID of the OBT and encrypted information being encrypted based on a private key of the OBT. The IoT device may transmit, to the blockchain node, a verification request signal including the second certification ID of the OBT.

### Advantageous Effects

According to an example of the present specification, by using decentralization, which is a method used in blockchains for decentralizing the processes of issuing and verifying certificates by adding additional information within a blockchain, the problem of security threats being concentrated in central locations may be resolved. Additionally, the disadvantage of separate production process(es) being added to the process of loading pre-issued certificates (or credentials) to a secure storage of each product/device may also be resolved.

### BRIEF DESCRIPTION OF THE FIGURES

FIG. 1 is a diagram showing an embodiment of an open connectivity foundation (OCF) device configuration.

FIG. 2 is a diagram showing an embodiment of an OCF light bulb (or lighting) device.

FIG. 3 is a diagram showing an embodiment of an OCF protocol stack.

FIG. 4 is a diagram showing an outline of an OCF Bridge technology.

FIG. 5 is a diagram showing a relationship between an OBT and Server/Client OCF devices.

FIG. 6 is a diagram showing an overall structure of the OCF PKI.

FIG. 7 is a diagram showing an embodiment of an organization structure of an OCF PKI.

FIG. 8 is a diagram showing an embodiment of a certificate-based Onboarding method.

FIG. 9 is a diagram showing an authentication flow among certificate-based OCF devices.

FIG. 10 is a diagram showing an embodiment of a connection method between an OBT and an OCF device (Device-to-Device, D2D).

FIG. 11 is a diagram showing an embodiment of a connection method between an OCF device and an OCF Cloud (Device-to-Cloud, D2C).

FIG. 12 is a diagram showing an embodiment of a connection method between OCF Clouds (Cloud-to-Cloud, C2C).

FIG. 13 is a diagram showing a basic structure of a blockchain.

FIG. 14 is a diagram showing an embodiment of a method of registering a certificate of a device to the blockchain.

FIG. 15 is a diagram showing an embodiment of a Blockchain OTM negotiation method between an OBT and a device.

FIG. 16 is a diagram showing an embodiment of an authentication method between devices generating a private key, after performing pre-authentication.

FIG. 17 is a diagram showing an embodiment of an authentication method between devices generating a private key, after performing authentication during the same time frame.

FIG. 18 is a diagram showing an embodiment of a method of managing authentication information within a blockchain.

FIG. 19 is a diagram showing an embodiment of a method of discarding authentication information within a blockchain.

FIG. 20 is a diagram showing an embodiment of a basic structure of a connection between a Cloud and a Device applying the Blockchain principle.

FIG. 21 is a diagram showing an embodiment of a TLS Handshake method between a Device and a Cloud applying the Blockchain principle.

FIG. 22 is a flowchart showing an embodiment of an IoT device operation method.

FIG. 23 is a flowchart showing an embodiment of an OBT operation method.

### DETAILED DESCRIPTION

In the present specification, ‘A or B’ may mean ‘only A’, ‘only B’ or ‘both A and B’. In other words, in the present specification, ‘A or B’ may be interpreted as ‘A and/or B’. For example, in the present specification, ‘A, B or C’ may mean ‘only A’, ‘only B’, ‘only C’, or ‘any combination of A, B, and C’.

A slash (/) or comma used in the present specification may mean ‘and/or’. For example, ‘A/B’ may mean ‘A and/or B’. Accordingly, ‘A/B’ may mean ‘only A’, ‘only B’, or ‘both A and B’. For example, ‘A, B, C’ may mean ‘A, B or C’.

In the present specification, ‘at least one of A and B’ may mean ‘only A’, ‘only B’, or ‘both A and B’. In addition, in the present specification, the expression ‘at least one of A or B’ or ‘at least one of A and/or B’ may be interpreted as ‘at least one of A and B’.

In addition, in the present specification, ‘at least one of A, B and C’ may mean ‘only A’, ‘only B’, ‘only C’, or ‘any combination of A, B, and C’. In addition, ‘at least one of A, B or C’ or ‘at least one of A, B and/or C’ may mean ‘at least one of A, B, and C’.

In addition, parentheses used in the present specification may mean ‘for example’. Specifically, when indicated as ‘control information (EHT-Signal) ’, it may mean that ‘EHT-Signal’ is proposed as an example of the ‘control information’. In other words, the ‘control information’ of the present specification is not limited to ‘EHT-Signal’, and ‘EHT-Signal’ may be proposed as an example of the ‘control information’. In addition, when indicated as ‘control information (i.e., EHT-Signal)’, it may also mean that ‘EHT-Signal’ is proposed as an example of the ‘control information’.

Technical features described individually in one drawing in the present specification may be individually implemented, or may be simultaneously implemented.

1. Open Connectivity Foundation (OCF)

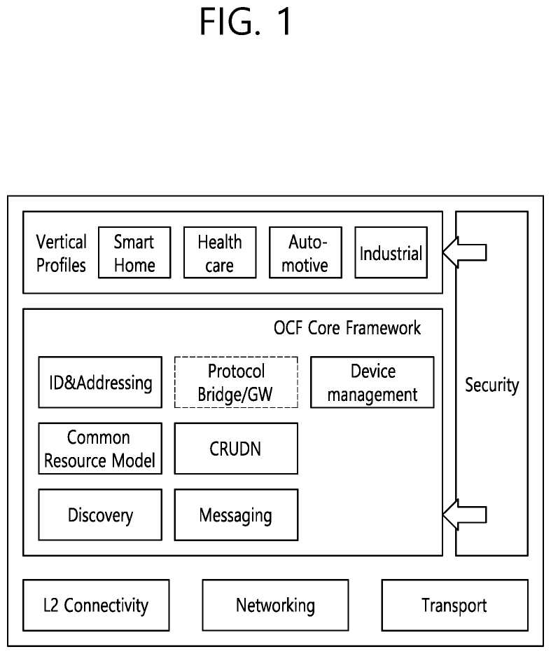

FIG. 1 is a diagram showing an embodiment of an open connectivity foundation (OCF) device configuration.

OCF adopts a Client-Server model, as a Representational State Transfer (RESTful) architecture, which is one of the broadest internet/web structures currently used by users. An OCF Client discovers neighboring OCF Servers and establishes a data exchange channel with the discovered neighboring OCF Servers, so as to accommodate and control, and manage information for receiving IoT services, which are provided by each server. Conversely, each OCF server defines an IoT service, which may be provided by the corresponding OCF server, as an OCF resource model and hosts the defined OCF resource model. Thereafter, by sending an appropriate response to a service request that is made by an OCF Client, the OCF server may provide an IoT service best-fitting the corresponding situation. For example, when an OCF Client is given as a smartphone, and when an OCF Server is given as a light bulb (or lighting device), IoT services that may be provided by the lighting device may be defined as resources, such as “Binary Switch (or Power Switch) (ON/OFF)”, “DIMMING”, “COLOR”, and so on. And, if the defined resources are modeled to a “Lighting (LIGHT BULB)” device in an OCF smart home, when an OCF Smartphone Service Application is executed from a smartphone, the smartphone user discovers the OCF “Light Bulb” and accordingly discovers the resources being provided by the OCF “Light Bulb”, such as Binary Switch, Dimming, Color adjustment, and so on. Thus, the smartphone user may be provided with the related light bulb control services.

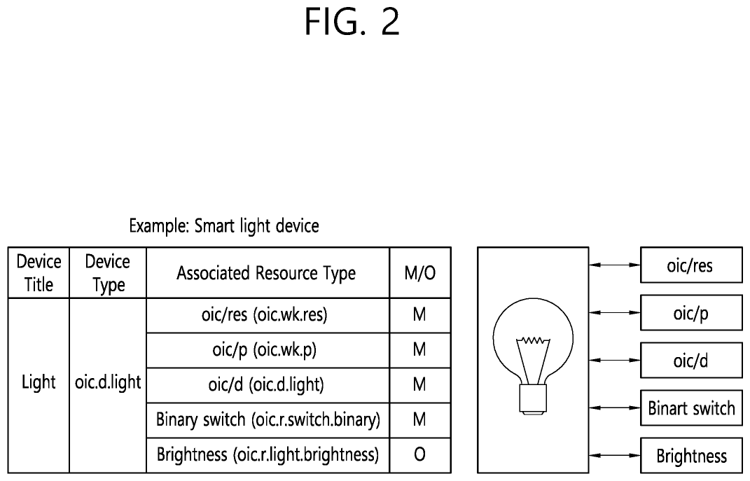

FIG. 2 is a diagram showing an embodiment of an OCF light bulb (or lighting) device.

Referring to FIG. 2, an OCF device may be configured by using OCF resource models. Herein, in order to simplify the understanding of the present specification, when it is given that the aforementioned light bulb (or lighting) device is being configured as the OCF device, it may be assumed that the power switch (or binary switch) and the dimming may be used as the functions being provided through the light bulb (or lighting) device. In order to configure such light bulb or lighting device as the OCF light bulb (or lighting) device, 1) “oic/res” being a resource used for the purpose of notifying (or informing) that an OCF resource model has been adopted (or selected), 2) “oic/d” being a resource used for the purpose of expressing an OCF “light bulb (or lighting) device”, 3) “Binary Switch” being a resource for expressing a power switch for the OCF light bulb (or lighting) device, and 4) “Brightness” being a resource for expressing a brightness adjustment function of the OCF light bulb (or lighting or light) device, are needed. A Boolean type “oic.r.switch.binary” is adopted in the “Binary Switch” resource, which corresponds to the power switch function of the OCF light bulb (or lighting) device, and an Integer type “oic.r.light.brightness” Uniform Resource Identifier (URI) is adopted in the “Brightness” resource, which corresponds to the brightness adjustment function of the OCF light bulb (or lighting) device. Generally, since the mandatory function(s) of a lighting device (or light bulb) is to turn the lighting device “ON and/or OFF”, in order to be approved (or accepted) as an OCF lighting device, the OCF lighting device shall be mandatorily configured of 1) the “oic/res” resource denoting an OCF resource model, 2) the “oic/d” resource denoting an OCF light bulb (or lighting) device, and 3) the “oic.r.switch.binary” resource denoting a binary switch (or power switch) function of the OCF light bulb (or lighting) device, and, since some devices do not provide the brightness adjustment function, the manufacturer of the OCF lighting device (or light bulb device) may optionally adopt the brightness adjustment function. Under the same principle, an “RGB Color” resource, which is a function for adjusting colors, may also be optionally added.

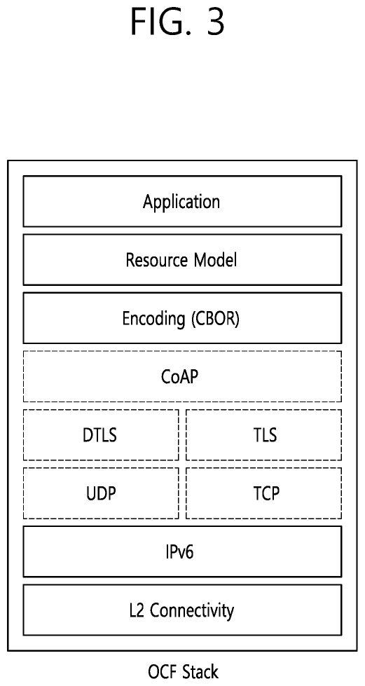

FIG. 3 is a diagram showing an embodiment of an OCF protocol stack.

Referring to FIG. 3, an OCF protocol stack may be expressed in layers. The OCF basically supports IPv6. In a situation where various wired/wireless devices, such as Bluetooth Low Energy (BLE) over IPv6, Zigbee-IP, Thread, and so on, in addition to Ethernet and Wi-Fi, this is to enable OCF to ensure mutual compatibility among various wired/wireless technologies. Based on a prediction that the number of lightweight IoT devices, which typically use less memory and are sensitive to power consumption, a Constrained Application Protocol (CoAP) is adopted over an IP layer as a protocol for searching, discovering, and controlling OCF devices. Herein, the CoAP is a communication protocol that is defined as an industrial standard, by an international Internet standardization body (the Internet Engineering Task Force (IETF)), for data exchange among lightweight IoT devices. Over the CoAP protocol, a Concise Binary Object Representation (CBOR) encoding scheme is adopted in order to encode content being defined according to the OCF resource models. Although the CBOR is an encoding scheme operating based on JavaScript Object Notation (JSON). For each of the resources being configured for operational optimization in a device having lightweight memory specs in JSON, 1) “oic.wk.res” is adopted in “oic/res”, which is an OCF “Well-Known” resource being used for notifying (or informing) that an OCF resource model has been adopted, 2) “oic.d.light” being the “OCF light device” is adopted in “oic/d”, which is a Device resource for expressing the OCF “light device”, and 3) having the necessary headers of an OCF light device removed and compressed as a binary type is adopted as an IETF standard. In this structure, the aforementioned OCF resource model is defined above such stack. And, an OCF application service using this stack is operated in this structure.

A Resource Directory (RD) function provided by OCF is also one of the methods for enhancing the power consumption issue. An OCF Client that wishes to be provided with an OCF standard based IoT service sends, to various OCF Servers existing with a specific network, a request for providing the corresponding service. At this point, since all of the OCF Servers respond to the service request, which is transmitted from the OCF Client, during this process, the transmission of response messages from the OCF Servers may inevitably cause unnecessary power consumption. However, if the RD function provided by OCF is used in such an environment, resource information being provided by the OCF Servers are separately hosted to another device having relatively sufficient surplus power, and, in case the OCF Client requests the corresponding service, instead of the OCF Servers, the device providing the RD function transmits a response message responding to the service request transmitted from the OCF Client. Thus, by performing the function (or role) of the OCF Server(s) instead, the unnecessary power consumption of the OCF Servers may be prevented. The OCF has contemplated a technical solution for providing mutual compatibility with another IoT standard technology, which was previously established in the market. And, as a result, OCF has established a Bridge standard specification.

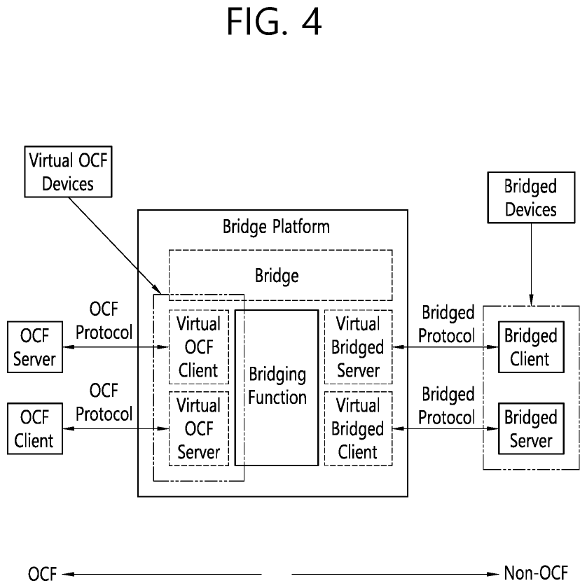

FIG. 4 is a diagram showing an outline of an OCF Bridge technology.

Referring to FIG. 4, an OCF Bridge may be conceptually expressed. A Bridge device is defined in the OCF Bridge specification. Herein, the device may be a separate physical Bridge device, or the device may be an existing OCF device additionally provided with a logical Bridge function. The OCF Bridge device provides a two-way Bridge function between an OCF ecosystem being interlinked to the OCF protocol and the corresponding ecosystem being interlinked to a specific protocol. For this, firstly, in order to be interlinked to neighboring OCF devices (OCF Client and Servers) through the OCF protocol, the OCF Bridge device hosts virtual OCF devices (Virtual OCF Client and Servers) corresponding to the neighboring OCF devices (OCF Client and Servers), respectively, and the OCF Bridge device has the corresponding protocol stack. Under such conditions. Similarly, the OCF Bridge device provides a Translator function converting and mapping data models between both blocs to one another, in a situation where status monitoring and control are needed between one another, while discovering/managing the information of the neighboring OCF devices and specific devices. Meanwhile, a data model for the OCF Bridge device is defined as “oic.d.bridge” in the specification.

Security is defined by OCF to be ensured for the purposes of 1) performing device certification for verifying whether communicating device is a reliable (or trusted) device, 2) ensuring data protection for establishing confidentiality and integrity based on messages being encrypted and signed, and 3) configuring user authority for data access control. For this, OCF security focuses on the usage of Secure Virtual Resources (SVRs) and an Onboarding Tool (OBT). Inter-device connection may be established based on (D)TLS. More specifically, when establishing Device-to-Device (D2D) connection, the devices may be interconnected based on DTLS, and, when establishing Device-to-Cloud (D2C) or Cloud-to-Cloud (C2C) connection, the devices may be interconnected based on TLS.

Apart from the OCF mandatory resources of a Server device, which is described in FIG. 2, Secure Virtual Resources (SVRs), which are separate resources for OCF security, shall be mandatorily implemented in all OCF devices. The mandatory SVRs defined in OCF security are configured of 1) /oic/sec/dxom (device ownership transfer method) providing an interface for verifying and configuring Device Ownership status, 2) /oic/sec/pstat (provision status) providing an interface for verifying and configuring Device Provisioning status after Device Ownership, 3) /oic/sec/ac12 (access control list) providing an interface for specifying which Client can use which function under what authority, among various functions provided by the OCF Server device, and 4) /oic/sec/cred (credentials) providing an interface for storing and using necessary credentials when generating a Secure Connection among OCF. And, OCF security related functions are configured by using such SVRs. Since the SVR contains sensitive information on an OCF device, only an OBT and service entities having the appropriate authority may access the SVRs.

The OBT may perform the role of an Onboarding Tool performing Ownership Transfer, which configures the ownership of a new OCF device. At this point, a Security Domain among OCF devices, which are onboarded by using the same OBT may be configured. And, by having the OBT perform Credential and Resource access authority configuration on each device, the OBT may mediate the connection among the corresponding devices. The OBT is configured of 1) a Device Ownership Transfer Service (DOTS), which is provided by the new OCF device to a method of performing Ownership Transfer with the OBT, 2) a Credential Management Service (CMS), which is used for managing the credentials of the new OCF device for establishing a connection among the devices, and 3) an Access Management Service (AMS), which manages an Access Control List of the new OCF device. Three different methods (Just-Work, Random PIN, Manufacturer Certificate) for OCF security are specified in the Ownership Transfer Method (OTM) of OCF devices. A Just Works OTM is a method of performing Ownership Transfer without any separate authentication process based on a presumption that devices being connected to a same network are reliable (or trusted) devices. And, a Random PIN OTM is a method of establishing reliability (or trust) when a value of a random PIN code generated by a Server device and a value of a random PIN code inputted to the PBT by a user are the same. Finally, a Manufacturer Certificate OTM is a method wherein a device provides a pre-issued certificate, which has been issued in advance by the manufacturer, to the OBT, and wherein the OBT verifies the pre-issued certificate.

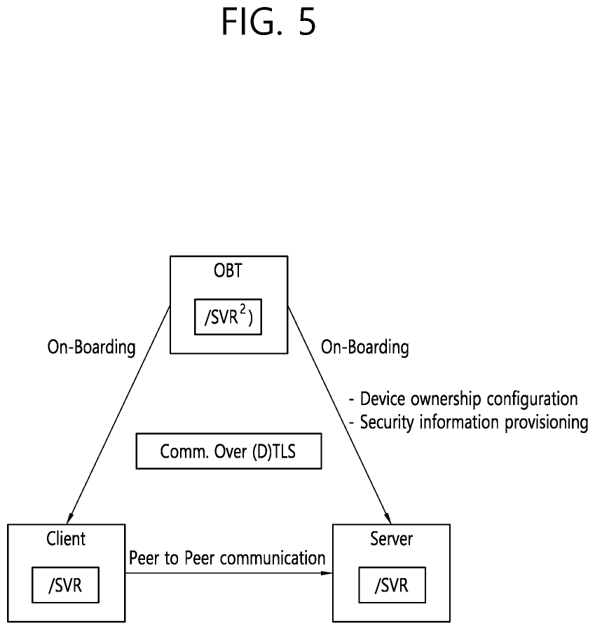

FIG. 5 is a diagram showing a relationship between an OBT and Server/Client OCF devices.

Referring to FIG. 5, Onboarding between the OBT and a new OCF device may be carried out in the following order. 1) The user may initiate the Onboarding process by releasing a new OCF device to carry out a first operation. 2) The OBT of the corresponding user may search for a new device via multi-cast and may discover the new device. At this point, a message may be transmitted through an unsecure channel between the OBT and the new device. 3) The DOTS may use one of the OTMs to perform Ownership Transfer, which transfers the ownership of the new device from the initially configured Device Manufacturer to the Device Purchaser. At this point, a Handshake process may be carried out in order to establish a (D)TLS connection between the OBT and the new device. Thereafter, once the Ownership Transfer is successfully carried out and the TLS connection is completed, 4) the CMS may update the credentials of the new device, and the AMS may update the access rights (or authority) for the new device. After completing the above-described Onboarding process, in order to establish connection with other OCF devices, the new device may deliver credentials that may be verified among the devices through the OBT. And, by registering one another's access rights (or authority) to the ACL, the device may register their data.

The OCF adopts a Public Key Infrastructure (PKI) in order to ensure high reliability and stability of a Manufacturer Certificate. Basically, based on a method of sending and receiving a public key to and from a communication subject and its counterpart, a common (or shared) key is formed, and encryption (or encoding) and decryption (or decoding) of a message are carried out. At this point, PKI is a method of vouching for the corresponding public key through a certificate (credential) issued by an official and trusted third-party certification authority. For example, 1) regarding information and a public key of Device A, a certification authority issues a certificate (credential) vouching that the device manufactured by the Manufacturer and the public key of the corresponding device are reliable and can be trusted. 2) After receiving the credential for the corresponding public key, Device B carries out a process for verifying the integrity of the corresponding credential (or certificate), and, then, if the corresponding credential proves to be reliable, 3) Device B carries out device authentication based on the information on Device A, which is included in the verified certificate. The OCF PKI operates based on a certificate policy (CP), wherein the policy for credentials among OCF devices is specified by the OCF PKI itself.

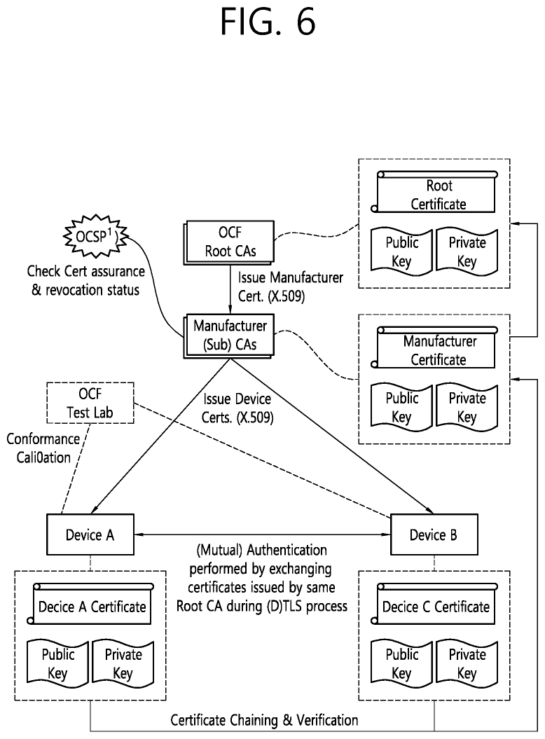

FIG. 6 is a diagram showing an overall structure of the OCF PKI.

Referring to FIG. 6, typical components of a general PKI include a Certification Authority (CA), a Registration Authority (RA), an Online Certificate Status Protocol (OCSP), and a Certificate Revocation List (CRL). All subjects generating, authenticating, and issuing a public key credential (or certificate) to other CAs or individuals will be referred to as CA. The CA is broadly categorized as a Root CA and an Intermediate CA. Most particularly, a Root CA means a top-level certification authority, and a certificate issued by the Root CA shall be self-signed (or self-authenticated). Conversely, the Intermediate CA means a lower-level certification authority. In OCF, a certification authority belonging to the Intermediate CA are manufacturers having their own CAs capable of issuing credentials (or certificates). And, in the OCF PKI, the Intermediate CA is referred to as a Manufacturer CA. In a method for mutually authenticating credentials of the Root CA and the Intermediate CA, the Intermediate CA issues a certificate (or credential) after having the Root CA sign, once again, the certificate, which has already been issued by the Root CA. Thus, the Root CA authenticates once again that the certificate, which was initially issued by the Root CA, is in fact a reliable certificate. Eventually, the PKI has a Certificate Chain, which is a mutual vouching system between a top-level certification authority and a lower-level certification authority.

In order to request for a certificate to a CA, a user shall register, to an RA, his/her personal identification information and other information that are to be registered to the issue certificate. The role of the RA is not only to receive registrations but also to authenticate the registered information to be true or false and, according to the authenticated result, to determine whether the CA should approve or deny the issuing of the certificate. In the OCF PKI, in order to be issued with a certificate for its public key, the OCF device shall complete a written Certification Application, which is provided by the RA.

In OCF security, an OCF device having a certificate (or credential) includes an End-Entity Certificate. According to the PKI, the corresponding End-Entity Certificate is authenticated by a top-level or lower-level certification authority. In the end, the OCF device having a certificate may not only include the End-Entity Certificate but may also include a certificate authenticated and issued by a Root CA or Manufacturer CA through the Certificate Chain.

The role of the OCSP is a protocol that allows the user to verify (or check) the status of his/her certificate by keeping track of a validity status of the certificate. As opposed to the OSCP, which only shows (or displays) valid certificates, the CRL is a protocol that only shows expired certificates.

A certificate being used in the OCF PKI typically means a Test Certificate. All OCF member companies prove, through the Test Certificate, that the OCF PKI of their products has been appropriately implemented. Afterwards, when the manufacturer sells the corresponding product(s) according to the OCF standard, the manufacturer shall include, in the corresponding product, a Production Certificate, which is registered to an OCF Certificate Management System (OCMS). The manufacturer shall apply for a certificate through a CA and RA, which are approved by the OCF, and, then, be issued with the certificate. According to the structure of the OCF PKI, the CA and RA are configured of two sets. In case of a manufacturer owning its own CA, the manufacturer needs to be issued with a Sub-CA certificate, so that a device certificate can be approved by the OCF PKI. Conversely, in case of a manufacturer that does not have its own CA, the device directly requests the RA for a certificate and is, then, issued with the request device certificate. The operation and management of the OCF PKI standard policy and a certification authority is performed through a Management Authority (MA).

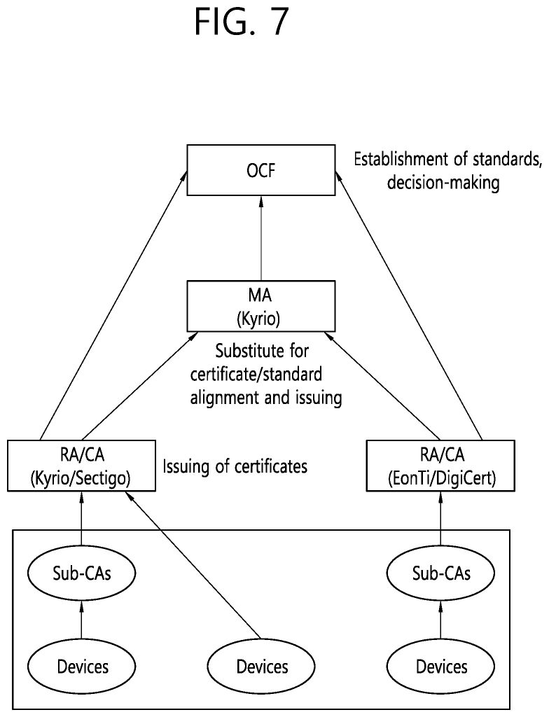

FIG. 7 is a diagram showing an embodiment of an organization structure of an OCF PKI.

Referring to FIG. 7, the OCF PKI mandatorily follows a certificate that is based on an X. 509 v3 format, or higher. In the OCF security standard, the Root CA, the Manufacturer CA, and the End-Entity defined the information that shall be included in the certificate. Details are shown below in Table 1.

TABLE 1

| Certificate Fields | | Root CA | Manufacturer CA | End-Entity (Black) |
|---|---|---|---|---|
| Mandatory | version | v3 (value is 2) | v3 (value is 2) | v3 (value is 2) |
| | Serial Number | unique positive | unique positive | unique positive |
| | | integer | integer | integer |
| | CA Signed Algorithm | ecdsa-with-SHA256 | ecdsa-with-SHA256 | ecdsa-with-SHA256 |
| | | (OID: | (OID: | (OID: |
| | | 1.2.840.10045.4.3.2) | 1.2.840.10045.4.3.2) | 1.2.840.10045.4.3.2) |
| | Issuer | Same as Subject | Same as Subject | Same as Subject |
| | | Name | Name of Root CA | Name of Intermediate |
| | | | | CA |
| | Subject | Same as Issuer Name | No Stipulation | o = OCF-verified |
| | | | | device manufacturer |
| | | | | organization name, |
| | | | | other attributes are no |
| | | | | stipulation |
| | notBefore | Issue time by | Issue time by | Issue time of End- |
| | | Root CA | Intermediate CA | Entity Certificate |
| | notAfter | No Stipulation | No Stipulation | No Stipulation |
| | Subject Public key | id-ecPublickey (OID: | id-ecPublickey | id-ecPublickey (OID: |
| | | 1.2.840.10045.2.1) | (OID: | 1.2.840.10045.2.1) |
| | | secp256r1 (OID: | 1.2.840.10045.2.1) | secp256r1 (OID: |
| | | 1.2.840.10045.3.1.7) | secp256r1 (OID: | 1.2.840.10045.3.1.7) |
| | | | 1.2.840.10045.3.1.7) | |
| Extensions | AuthorityKeyIdentifier | (optional) | (optional) | (optional) |
| | SubjectKeyIdentifier | (optional) | (optional) | (optional) |
| | KeyUsage | (required) | (required) | (required) |
| | CertificatePolicies | | (optional) | (optional) |
| | SubjectAlternativeName | | | (required under |
| | | | | certain condition) |
| | BasicConstraints | (required) | (required) | (required) |
| | ExtendedKeyUsage | | | (required) |
| | Authority InfoAccess | | (optional) | (optional) |
| | CRLDistributionPoint | | (optional) | (optional) |
| | OCF Complaince | | | (optional) |
| | Manufacturer Usage | | | (optional) |
| | Description (MUD) | | | |
| | OCF Security Claims | | | (optional) |
| | OCF CPL Attributes | | | (optional) |

In OCF security, a certificate (credential) is used when Ownership Transfer is carried out between a new OCF device and an OBT, and when OCF devices having completed the Onboarding with the OBT are authenticated. The corresponding certificates represent X. 509 type certificates being authenticated by a third-party certification authority based on the OCF PKI.

An OCF device uses its certificate for the first time during the Onboarding process with the OBT. Among the Ownership Transfer Methods, when using the Manufacturer Certificate OTM on the OBT, the OCF device uses the certificate to authenticate the device and to exchange the public key. At this point, information of the corresponding certificate shall be mandatorily and accurately indicated in a resource (“/oic/sec/cred”) expressing the corresponding certificate, as specified in the OCF security standard.

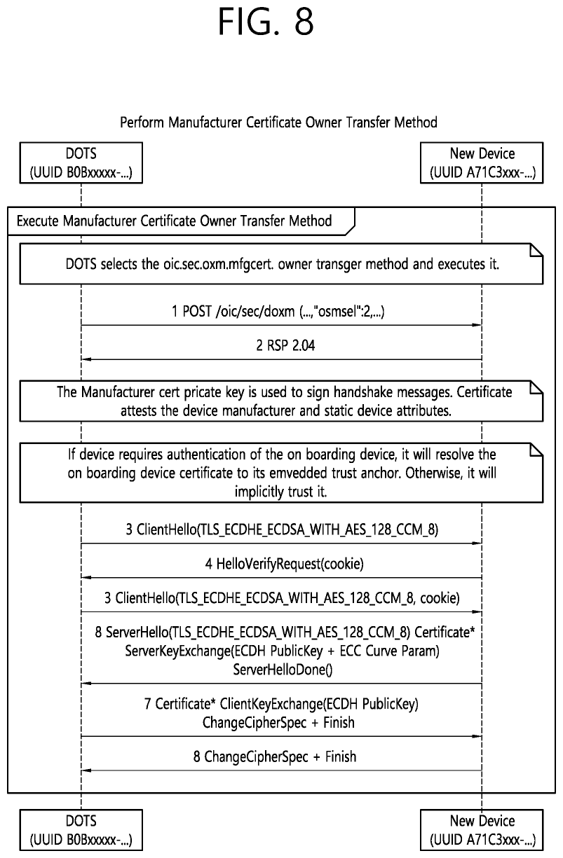

FIG. 8 is a diagram showing an embodiment of a certificate-based Onboarding method.

Referring to FIG. 8, the Ownership Transfer using credential is performed based on a (D)TLS Handshake process. In Step 1˜Step 2, an OBT sends messages to multiple devices via multi-cast by using a non-encrypted channel, so as to search for OCF devices that need onboarding. And, when a new OCF device that need onboarding is discovered, Step 3 is initiated so as to carry out the (D)TLS Handshake process. In OCF security, the process of forming a TLS follows RFC 5246. According to a supportable cipher suite that is defined in the OCF security standard, when exchanging keys in the Manufacturer Certificate OTM, only a cipher suite supporting ECDSA, which is a technique using a certificate in order to authenticate a counterpart shall be used.

A certificate is also used when performing mutual authentication for establishing a DTLS communication channel among OCF devices having completed onboarding with the OBT. And, this method (or scheme) is referred to as an Asymmetric Credential scheme in OCF security. When the new OCF device completes onboarding with the OBT in order to belong to an OCF Security Domain, this is when the OCF devices finally satisfy the conditions needed for establishing communication among one another.

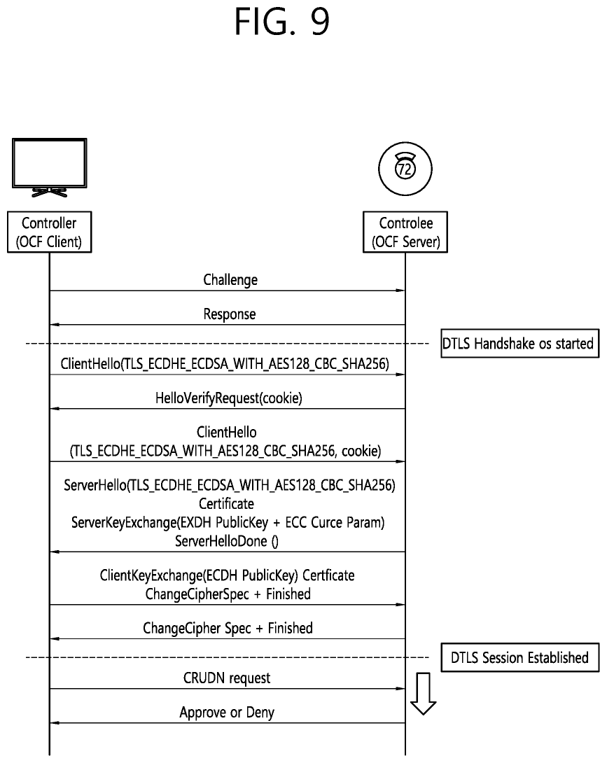

FIG. 9 is a diagram showing an authentication flow among certificate-based OCF devices.

Referring to FIG. 9, the generation of a communication channel among OCF devices may be performed based on the DTLS Handshake process, just as the Onboarding procedure. Herein, also, a cipher suite that is agreed with a counterpart OCF device shall only use a scheme including ECDSA, which authenticates the counterpart by using the certificate at a Key Exchange Algorithm part.

For mutual authentication among devices, the mutual authentication may be performed by using a related art certificate. The device stores the certificate, which is issued by an official and trusted certification authority, within the device, and the OBT authenticates the device based on the information of the corresponding certificate, so as to configure a Secure Session of a mutual Transport layer or a Transport layer between the device and a cloud.

In the OCF standard, three different types of connection schemes are defined in accordance with the device connection scheme:

1) Communication connection between OCF devices within a local network (Device-to-Device (D2D)),

2) Communication connection between an OCF device and an OCF Cloud within a remote network (Device-to-Cloud (D2C))

3) Communication connection between OCF Clouds.

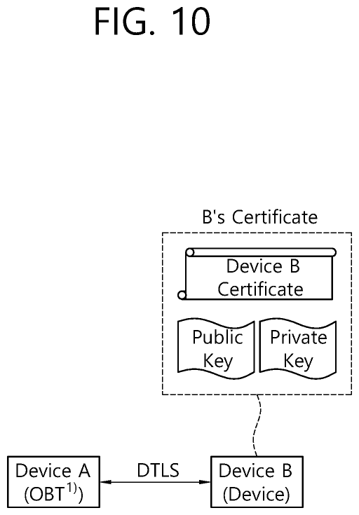

FIG. 10 is a diagram showing an embodiment of a connection method between an OBT and an OCF device (Device-to-Device, D2D).

Referring to FIG. 10, in OCF, the D2D connection method is one of the connection methods between OCF devices. And, herein, the D2D connection method means connected communication between the OBT and an OCF device. When performing an Onboarding operation between an Onboarding Tool (OBT), which plays a central role in OCF security, and a new OCF device in order to register the new device to the OCF network, the communication connection between the two devices shall be established through a local network. That is, when performing Onboarding with the OBT, the connection between the two devices shall be established by using the D2D method, which is based on DTLS. Before the Onboarding process is actually performed, the new OCF device is required to prove to the OBT that the new OCF device has been developed in conformance to the OCF specification and that the new OCF device has been verified (or checked) through a legitimate verification procedure. Currently, the OCF specifies the proving method as a total of three different types: 1) authentication through a public key certificate, which is authenticated based on PKI (Certification based OTM), 2) authentication by inputting a key being transmitted out-of-band from the OBT (Random PIN based OTM), and 3) authentication without performing any specific procedure (Just-Work OTM).

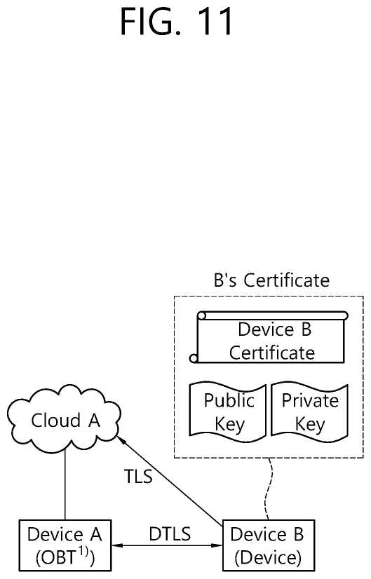

FIG. 11 is a diagram showing an embodiment of a connection method between an OCF device and an OCF Cloud (Device-to-Cloud, D2C).

Referring to FIG. 11, the D2C connection method means a connection method between an OCF device and an OCF Cloud. Currently, in the OCF, in order to connect a new OCF device with an OCF Cloud, channels for 1) a connection between an OCF device and an OBT, 2) a connection between an OBT and an OCF Cloud, and 3) a connection between an OCF device and an OCF Cloud are basically needed. Firstly, the OCF device authenticates itself based on a public key certificate by being connected to the OBT in a D2D method, and, then, the OCF device completes the Onboarding process. In order to obtain access rights (or authority) from the OCF Cloud, the OBT may use OAuth2.0 (which is based on RFC6749), which is a user-account-based authentication framework. The OBT transmits information (Access Token, Cloud URI, UserID, and so on) that are needed by the OCF device, from the OCF Cloud, in order to establish a communication connection to a remote network. After receiving the corresponding information from the OBT, the OCF device carries out authentication through a public key certificate, which is authenticated based on PKI, and TLS channel generation with the OCF Cloud.

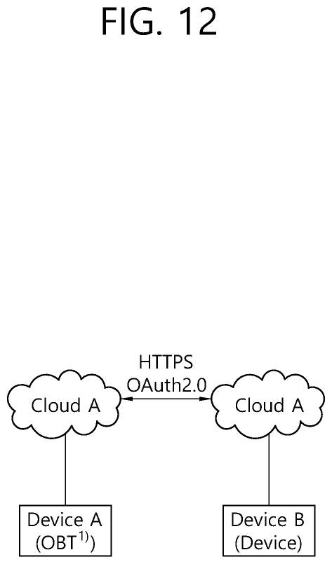

FIG. 12 is a diagram showing an embodiment of a connection method between OCF Clouds (Cloud-to-Cloud, C2C).

Referring to FIG. 12, the C2C connection method is a connection between an OCF Cloud and another OCF Cloud. Herein, the OCF Cloud means a Cloud created by OCF or a Cloud of a manufacturer that is authenticated by OCF. According to the current OCF specification, the connection between clouds may use the authentication framework OAuth2.0 (RFC6749) based on a Cloud account.

2. Blockchain Technology

As a collection of blocks being chained to one another, Blockchain is a type of financial book containing, in a block, transaction history that is confirmed during a predetermined time period. The blockchain technology is a technology enabling all nodes (peers) to store and update a ledger (blockchain), which contains all transaction information occurring in a Peer-to-Peer (P2P) network, and to maintain integrity. The blockchain technology, which was initiated by Bitcoin, has recently been integrated with FinTech and is being adopted to various fields.

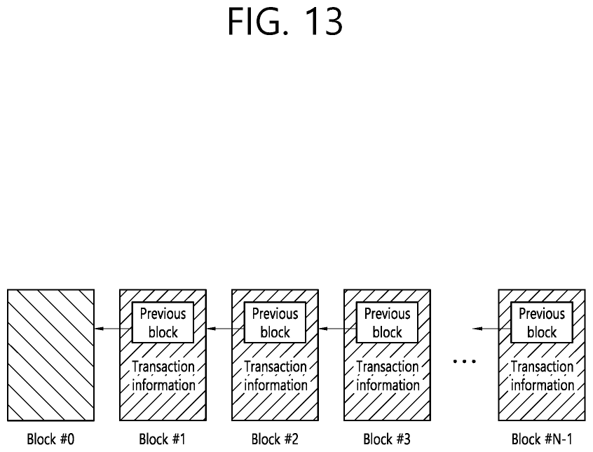

FIG. 13 is a diagram showing a basic structure of a blockchain.

Referring to FIG. 13, in a blockchain structure, since a block is generated by including information (hash value) of a previous block, current transaction information and has value, and so on, the content of the block cannot be tampered, and since the transaction information is made public (or open to public), the blockchain may be transparently managed. The components of each blockchain are associated with those of the previous blockchain, and, since the cryptographic characteristics of a hash function is used, integrity may be ensured. And, although a blockchain of a tampered transaction may be generated by misusing the hash value, since the length of a blockchain denotes its reliability, a tampered blockchain is removed by default.

The components of a blockchain are as listed below.

(1) Peer-to-Peer (P2P) network: Many of the existing network systems have a Client-Server structure, in which multiple clients (users) are connected and managed only through a centralized server. Conversely, in the blockchain, all users are connected by an equal layer based on a P2P network. Thus, the users perform the role of servers as well as clients at the same time.

(2) Distributed ledger: A distributed ledger is a feature allowing the decentralization of the blockchain. The distributed ledger is replicated and shared under a consensus among the participants, and synchronized information is recorded (or stored) in a storage unit, which is referred to as a block. Most particularly, in order to apply the distributed ledger to the P2P network, a consensus among the participants is needed for the recording of the distributed ledger. In the blockchain, the distributed ledger records all transactions and information after processing a verification process of the participants. Accordingly, all participants share the same information.

(3) Cryptographic technology: Generally, the term Cryptocurrency is used for referring to currency operating based on blockchain. This is because the cryptographic technology is the key technology in blockchain. In the cryptographic technology, the most typical techniques are Digital Signature and Cryptographic hash, which are based on the Public Key Infrastructure (PKI). The PKI may be understood as a commonly used certified authentication system, and the PKI is used to prevent denial of a transaction made on the blockchain. Cryptographic hash is an important elemental technology in that, since an output value for a specific input value can be easily known, but, in reverse, since it is impossible to track an input value corresponding to a given output value, the integrity of blockchain data may be maintained, and that connectivity among distributed ledgers is provided.

(4) Distributed consensus: This term denotes one of the technologies that are being researched extensively in the field of distributed processing in computer science. Herein, the distributed consensus is being used as an element allowing all participants to maintain a matching (or conforming) distributed ledger. That is, due to the characteristic of blockchain requiring all users to have the same record, a process in which all participants determine the suitability of the data and accept the determined suitability is needed. This process is carried out through a distributed consensus. And, herein, the most characteristic methods of distributed consensus are Proof of Work (PoW) of the bitcoin blockchain and/or Proof of Stake (PoS) of the Ethereum blockchain.

(5) Smart contract: The Smart contract was first presented by Nick Szabo. The Smart contract is a protocol for electronic commerce (E-commerce, EC) for minimizing mediators for a trusted (or reliable) transaction and for executing specific terms of contract. Blockchains succeeding the Ethereum blockchain, which is referred to as a second (2^{nd}) generation blockchain, supports such smart contracts, thereby enabling the transaction parties to carry out a direct transaction without any mediator or central agency. Meanwhile, the smart contract also keeps a record of the terms (or conditions) and result of a business transaction, thereby ensuring reliability and integrity of the transaction information.

The blockchain has the characteristics of distributiveness due to the P2P-based distributed processing method, extensibility allowing any party to participate, transparency allowing access to all content, and so on.

TABLE 2

| | |
|---|---|
| Distributiveness | Transaction can be made in a distributed network (P2P) environment |
| | without any trusted third-party |
| | Cost needed for the management, maintenance, and so on, of a centralized |
| | system is reduced. |
| Extensibility | The building • connection • extension can be carried out by any network |
| | participant by using a public source. |
| Transparency | Public access is allowed for all transaction records. |
| | Cost needed for legalization and regulation of transactions is reduced. |
| Security | By allowing all network participants to have joint ownership of the |
| | transaction history book, tampering of transaction data may be prevented |
| | and integrity may be ensured. |
| Stability | As a distributed network structure, a singular point of failure does not exist. |
| | When an error or performance degradation occurs is some of the |
| | participating systems, the entire network is affected. |

3. Security Standard Technologies

Although the OCF security develops its own technologies, the OCF security also configures an OCF IoT platform by applying the existing security standard technologies, which are selected by mass adoption. The technologies applied in OCF security are generation process and verification process of a public key certificate that are based on an electronic signature scheme, which is used for device authentication.

The public key certificate is a certified document with approved reliability by having authority information of a subject party and information on the public key authenticated by a third-party certification authority. When using the public key certificate in OCF, the certificate is based on the X. 509 specification (RFC 5280). In order to describe the generation process, a situation where Device A generates a certificate is assumed herein. The process of generating a certificate by Device A is described as follows. 1) Authority information of Device A is applied to a Hash algorithm so as to derive a Hash value. 2) Encryption of the corresponding Hash value is carried out by using a private key of the subject party, and 3) the encrypted result value, authority information of Device A, and the public key are included in a certificate document, thereby issuing the certificate. After the counterpart receives the certificate of the subject party, the counterpart mandatorily performs a verification process verifying whether or not a problem exists in the integrity of the corresponding certificate. For the description of the verification process, a situation in which Device B has received the certificate of Device A is assumed herein. The process of verifying the certificate of Device A is described as follows. 1) After receiving the certificate of Device A, Device B uses the authority information of Device A to derive a Hash value by using the same Hash algorithm used in Device A. 2) Decoding of the encrypted hash value is performed by using the public key of the subject party, which is sent from Device A, and, then, the result value is compared with the Hash value derived by Device B. According to the compared result, if the values are the same, the certificate is determined to be valid, and the communication connection with Device A is carried out. However, if the values are not the same, the connection with Device A is rejected.

A security protocol that is used for safely transmitting a message over a Transmission Control Protocol (TCP) is referred to as Transport Layer Security (TLS), and a security protocol for safely transmitting a message over a User Datagram Protocol (UDP) is referred to as Datagram Transport Layer Security (DTLS). In OCF, Device-to-Device (D2D) communication is performed over UDP, and Device-to-Cloud (D2C) communication and Cloud-to-Cloud (C2C) communication are performed over TCP. When using the (D)TLS in OCF, the (D)TLS is based on a v1.2 (RFC 5246) specification. TLS/DTLS performs encryption in order to deliver a message safely. At this point, in order to allow the counterpart to perform encryption/decryption by using the same encryption key, a handshake process for mutually agreeing on a cipher suite is performed. The configuration of the cipher suite indicates 1) a scheme for exchanging public keys with a counterpart (Key Exchange Algorithm), 2) a scheme for encrypting a message (Bulk Encryption Algorithm), and 3) a scheme for authenticating the integrity of the message and the counterpart (Message Authentication Code). In OCF security, the counterpart is authenticated by using each specific method based on the characteristics of the Ownership Transfer Method (OTM), and the public keys of both parties (or ends) are exchanged. In case of using the Just-Work OTM, only the method including ANON (Anonymous) in the Key Exchange Algorithm shall be used. And, in case of using the Random PIN OTM, only the method including a Pre-shared Key (PSK) shall be used. And, in case of using the Manufacturer Certificate OTM, only the method including an ECDSA shall be used. In order to establish a (D)TLS session, a Handshake process with the counterpart is required. Herein, a situation for establishing a TLS session between Device A and Device B is assumed. 1) In an initial negotiation step, Device A delivers a list of supportable cipher suites to Device B. 2) Subsequently, as an authentication step, among the received list of cipher suites, Device B selects one cipher suite and authenticates its counterpart. The delivery or non-delivery of the certificate is determined in accordance with the components of the cipher suite. Device A authenticates Device B in accordance with the method determined by the cipher suite. If the authentication method of Device B is based on the certificate, Device A and Device B may verify each other's certificate and may verify the period of validity (or expiration date) of the certificate through the certification authority, which had issued the corresponding certificate. 3) Device A and Device B exchange keys based on the agreed cipher suite and create a common key for message encryption and decryption. 4) After verifying whether or not a common key has been made, a mutually encrypted communication between Device A and Device B is initiated.

Hereinafter, a method enabling mutual authentication to be performed between devices by using the blockchain technology will be proposed. Most particularly, instead of a mutual authentication based on a certificate, which is issued by a certification authority (CA) managing authentication at the center, as in the conventional method, proposed herein is a mutual authentication method between devices using a method of establishing an agreement between authentication nodes based on a distributed blockchain. The present specification proposes an authentication technique between devices based on a blockchain, and proposes a method of adopting the authentication technique to an IoT environment, such as OCF, so as to apply the technique for performing initial authentication of a device and for configuring device ownership. Also, the present specification additionally proposes a new service model applying the corresponding technique.

An example of the present specification is to resolve the problems lying in a method of authenticating a device by using a certificate being stored and included in the corresponding device according to the conventional PKI method, i.e., the problems lying in all devices being required to have a certificate in advance (i.e., upon production), and a central Certification Authority (CA) being required to be maintained in order to issue certificates and perform authentication through a separate process. In case of maintaining a central Certification Authority (CA) in order to issue certificates and perform authentication, in terms of security, it is advantageous in that the certificates issued by a trusted authority. However, it will be disadvantageous in that any possible security threat is concentrated to the central location. Additionally, the process of loading the pre-issued certificates to a secure storage of each product, device, and so on, is disadvantageous in that separate process steps are being added to the production process. Also, even in case of actually performing device authentication based on a loaded certificate, a device (or enrollee) that is to be authenticated transmits its certificate to another device (OBT or authenticator) that is to perform the authentication. And, the device that is to perform the authentication needs to perform a separate process of verifying the credibility of the corresponding certificate with its issuer (i.e., the central CA).

Hereinafter, a method for resolving the above-described disadvantages by carrying out processes of issuing and verifying a certificate, through a decentralized method, such as the blockchain, will be proposed.

The present specification proposes a process of negotiating in order to use the blockchain for authentication between IoT devices, a process of generating authentication information using the blockchain, a process of verifying authentication information between devices, a process of configuring ownership of a device after verifying its authentication, a process of managing and discarding the authentication information. Additionally, the present specification also proposes a process of verifying authentication information between a cloud and a device through blockchain authentication information between a device and a cloud and generating a security channel. Furthermore, the present specification additionally describes a business model that may be implemented to the blockchain authentication information through additional information.

4-1. Method of Generating Authentication Information Through a Blockchain

A manufacturer issues a public key certificate for devices and stores the issued certificate inside the Device during the production process, or enables the Device to download the public key certificate at a point where the Device is connected to the Internet. As described above, a certification authority (CA) of manufacturers capable of issuing certificates is referred to as a Manufacturer CA.

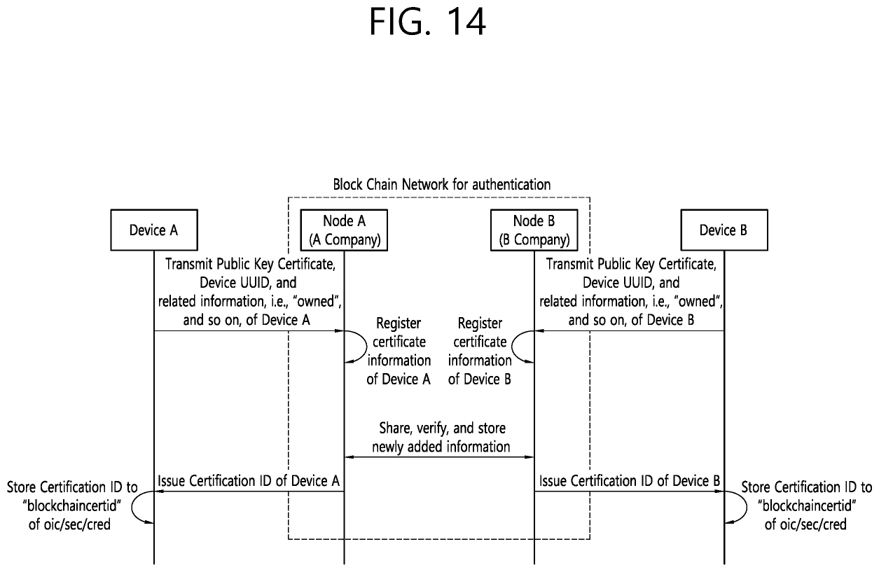

FIG. 14 is a diagram showing an embodiment of a method of registering a certificate of a device to the blockchain.

Referring to FIG. 14, prior to carrying out the actual Onboarding process, devices that are to carry out Onboarding may transmit, to a Blockchain node, a public key certificate stored inside the corresponding device and information related to the public key certificate. After receiving the information, the node may register and store the corresponding certificate through a verification process among other nodes. The Node that has received the information of the device for the first time may generate and transmit a Certification ID being mapped to the information transmitted to the device by one-to-one (1:1) mapping. The device may store the Certification ID received from the Node in an internal resource. For example, in case of OCF, “blockchaincertid”, an attribute of an oic/sec/cred resource, which stores the information related to the credential of the Device, may be stored. Based on this value, another device may verify a certificate within the Blockchain during a future verification process.

4-2. Method of Negotiating an Authentication Method by Using a Blockchain

In the OCF specification, each OTM is assigned with a number, such as 0 (Just-Work OTM), 1 (Random-Pin OTM), and 2 (Manufacturer OTM), so as to indicate the type of OTM supported by the OCF device and to indicate the selected OTM. If the device supports an OTM that is based on a blockchain, in order to express the corresponding capability a new value of 3 (Block Chain OTM) may be defined so as to indicate the new OTM scheme.

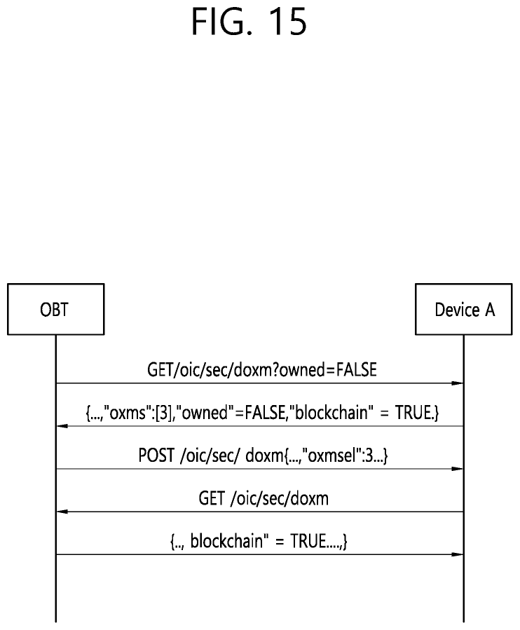

FIG. 15 is a diagram showing an embodiment of a Blockchain OTM negotiation method between an OBT and a Device.

Referring to FIG. 15, a Block within a Blockchain is stored in an entity, which is referred to as a Node. Such nodes may be connected to one another so as to configure a Network, which is configured in a P2P format. In case of performing mutual authentication by using the Blockchain, two devices shall be capable of accessing the Node. The device(s) shall be expressed by using a new attribute “blockchain”, which indicates access or non-access of a Blockchain Node (TRUE/FALSE). For example, if “blockchain”=TRUE in oic/sec/doxm of OCF Device A, this means that OCF Device A is a device that is capable of accessing the Blockchain Node.

An OBT requesting an initial authentication verifies the Capability of an authentication method (OTM) that is supported by Device A, by using a GET command (or instruction). At this point, in case Device A supports an authentication using the Blockchain, Device A includes the value 3 (Block Chain OTM), which indicates the corresponding Capability, and Device A may respond to a Blockchain enable parameter, which indicates accessibility to a Blockchain Node, as TRUE. In case the OBT sends a response indicating that it will attempt to perform authentication by using the blockchain, Device A selects and transmits the value 3 (Block Chain OTM), by using a POST command (or instruction). In relation to this, Device A may additionally verify the accessibility of a counterpart device to the Blockchain node by using the oic/sec/doxm resource.

4-3. Method of Configuring Device Authentication and Device Ownership by Using a Blockchain

Herein, the method may be divided into a method of performing authentication by using a blockchain firstly, prior to performing a TLS/DTLS Handshake, and a method of performing authentication during a TLS/DTLS Handshake process.

The first method is a method of completing mutual authentication between the devices, based on authentication information being registered within a blockchain, and generating a private key through a TLS/DTLS Handshake process.

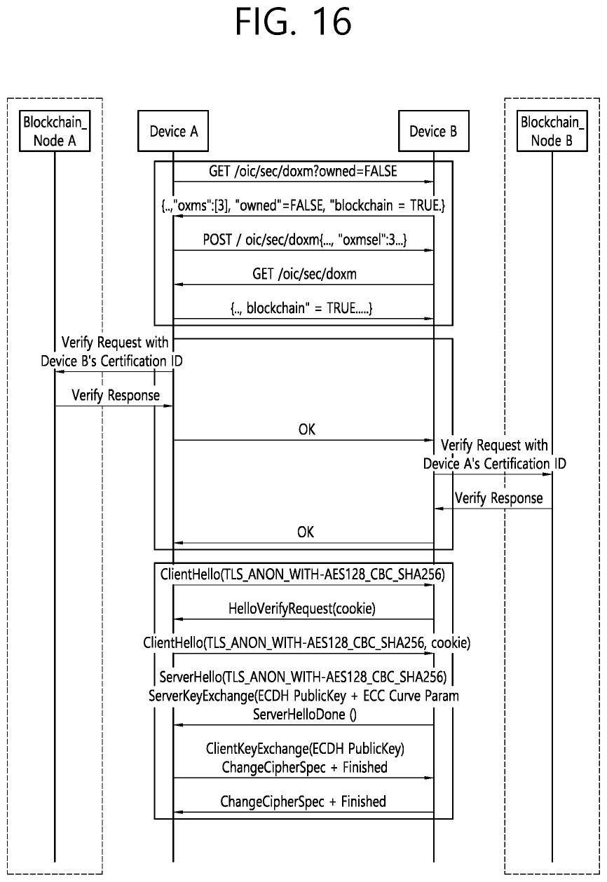

FIG. 16 is a diagram showing an embodiment of an authentication method between devices generating a private key, after performing pre-authentication.

Referring to FIG. 16, after two devices have carried out a negotiation process for an authentication method using a previous blockchain, each of the two devices may access the Blockchain so as to verify each other's public key authentication information by using a certification ID of its counterpart, which is obtained via out-of-band. Success/Fail of the verification result may be notified to each counterpart. Herein, when both Devices show results that the authentication information of the corresponding counterpart is ‘valid’, this means that the authentication procedure of the device(s) has been successfully completed. As a subsequent step, the two Devices may perform TLS/DTLS handshake in order to generate a private key. Herein, since the authentication of a counterpart device by using the blockchain has already been completed, a separate authentication process is not required during the TLS/DTLS handshake process. An ANON cipher suite (e.g., TLS_ECDH_ANON_WITH_AES_256_CBC_SHA256 (with the value 0xFF01)) may be used as the cipher suite being negotiated during the corresponding handshake. The ANON cipher suite is a method of handing out a public key without performing any separate authentication on its counterpart.

The following method is a method of carrying out an authentication process on a counterpart device, which public keys are being exchanged, during a TLS/DTLS Handshake, in order to generate a private key. This is different from the conventional authentication method, wherein a PKI public key certificate is directly transmitted to a counterpart for verification, in that a device verifies the credential (or certificate) information of its counterpart by accessing a Blockchain Node.

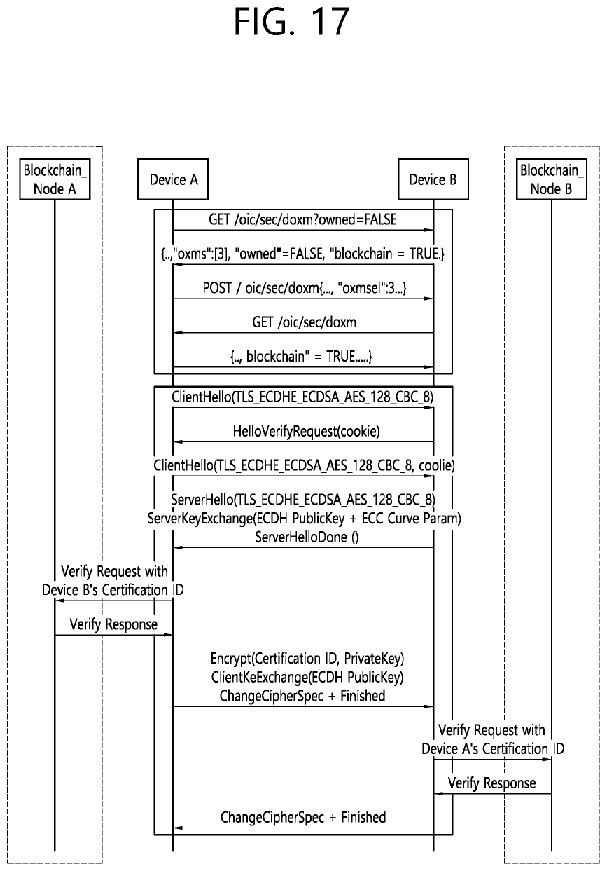

FIG. 17 is a diagram showing an embodiment of an authentication method between devices generating a private key, after performing authentication during the same time frame.

Referring to FIG. 17, in order to perform authentication between Device A and Device B, Device B may transmit, to Device A, a ServerHello message for cipher suite negotiation and a ServerKeyExchange message for public key exchange. At this point, Device B may encrypt a Certification ID (a value of the attribute “blockchaincertid” of “oic/sec/cred”) indicating credential (or certificate) information within the Blockchain to a private key, which is then transmitted along with the messages. Device A may verify the authentication information of Device B within the Blockchain by using the received corresponding information. The same method may be performed when Device A authenticates Device B. When Device A transmits, to Device B, a ClientKeyExchange message for public key exchange, Device A may also transmit an encryption result of a Certification ID, which indicates the credential information of Device A within the blockchain, being encrypted to the private key along with the message. Device B may verify the authentication information of Device A by accessing a corresponding Blockchain Node. When Device A and Device B respectively verify that the certificates of their counterparts within the Blockchain are both “valid”, the two Devices may calculate a common private key based on each of the received public keys.

4-4. Method of Managing, Updating, and Discarding Authentication Information

The public key authentication information of a Device being registered to the Blockchain may be initially registered by a subject of the corresponding information. Moreover, the actions of managing, updating, and discarding the authentication information may also be requested only by the subject of the corresponding information to ensure stability of security. When the Blockchain Node receives a request message, the Blockchain Node may request a Device UUID to be mandatorily included in the request message. By using the Device UUID, the Node may verify the subject of the authentication information, so as to request managing, updating, and discarding of the corresponding authentication information.

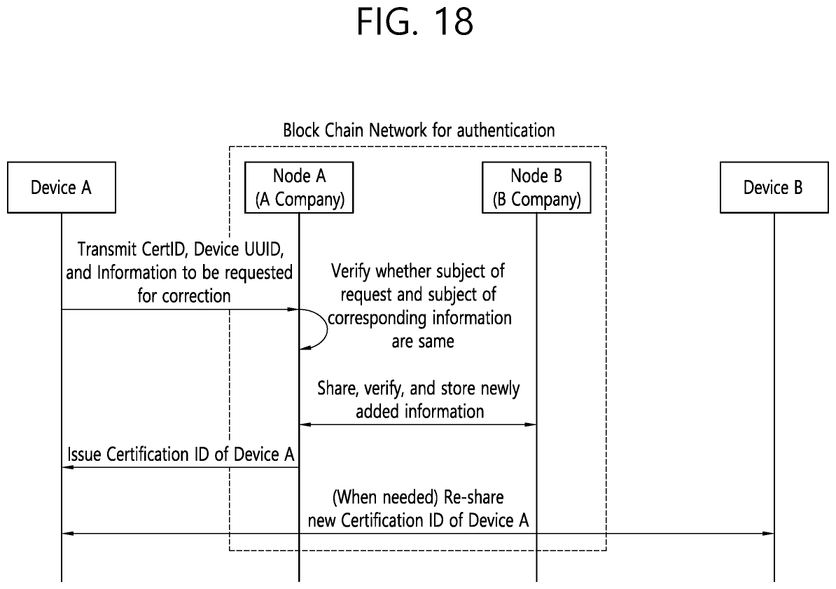

FIG. 18 is a diagram showing an embodiment of a method of managing authentication information within a blockchain.

Referring to FIG. 18, firstly, the Device may request a correction of the authentication information, which was initially registered to the Blockchain Node. Device A may transmit, to Node A, a message including a Certification ID, a Device ID, and information that is to be requested for an update. After receiving the message, Node A may verify whether the Device UUID being included in the transmitted message and a Device UUID being stored in the authentication information of the corresponding Certification ID are the same. If the two Device UUIDs are the same (i.e., match), Node A may perform the task requested by Device A and may then share the new information with other nodes. Thereafter, by transmitting a Task complete (“Success”) message and a new Certification ID to Device A, the task of Node A may be ended. Whenever needed, Device A may encrypt a new Certification ID to a private key of Device A, which is then transmitted to Device B.

For example, in case Onboarding with a specific OBT is completed in OCF, a value of attribute “owned” of oic/sec/doxm of the Device may be changed from FALSE to TRUE. This means that the corresponding Device has successfully delivered the Ownership to the OBT and that the ownership has been registered to the OCF Network. With the successful completion of the Onboarding process of the Device, if the attribute “owned” becomes TRUE, the Device may transmit, to the Node, a request message requesting the owned information to be corrected.

As another embodiment, the period of validity of the public key certificate of the Device may be updated. Generally, the public key certificates have limited validity for each authentication information. And, the corresponding public key authentication information is valid (or effective) only during this period of validity, and, once the validity of the certificate is expired, the corresponding authentication information cannot have any meaning. Therefore, in order to update (or renew) the period of validity of its certificate, the Device may request the Node to correct (or renew) the period of validity for authentication.

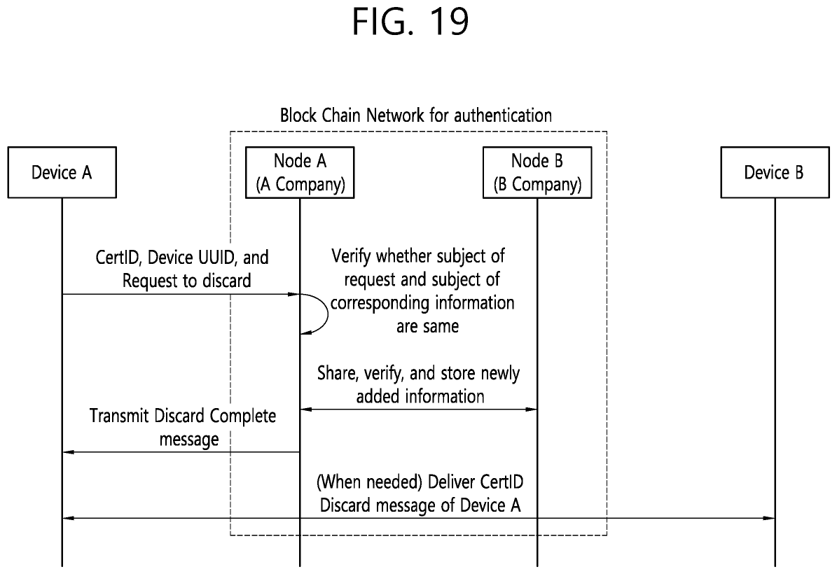

FIG. 19 is a diagram showing an embodiment of a method of discarding authentication information within a blockchain.

Referring to FIG. 19, Device A may transmit, to Node A, a discard request message including the Certification ID and the Device ID. After receiving the message, Node A may verify whether the Device UUID being included in the transmitted message and a Device UUID being stored in the authentication information of the corresponding Certification ID are the same. If the two Device UUIDs are the same (i.e., match), Node A may perform the discarding task requested by Device A and may then share the new information with other nodes. Thereafter, by transmitting a Task complete message to Device A, the task of Node A may be ended. Whenever needed, Device A may inform (or notify) Device B that the initially shared Certification ID can no longer be used.

4-5. Authentication Method Using a Blockchain Between a Device and a Cloud

According to the OCF standard, a connection between a Device and a Cloud may be established based on TLS. At this point, the Device may access the Cloud by using information on the Cloud, which is provided by a Mediator. By performing a TLS Handshake, the Cloud may authenticate the Device and may, then, generate a common (or shared) private key. In the corresponding case, it is defined by OCF that the Device shall perform authentication based on a PKI certificate. Unlike the conventional method, authentication may also be performed by using the Blockchain principle.

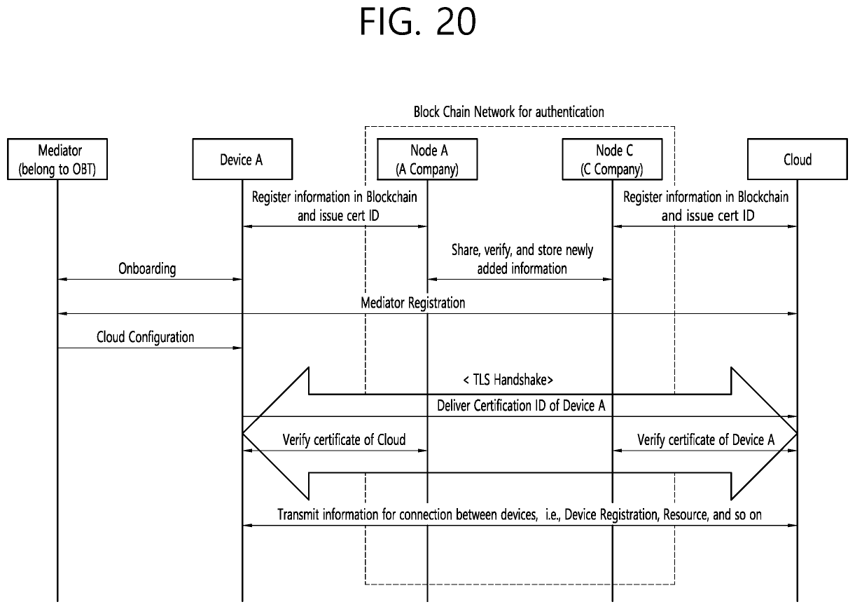

FIG. 20 is a diagram showing an embodiment of a basic structure of a connection between a Cloud and a Device applying the Blockchain principle.

Referring to FIG. 20, Device A may register the public key certificate information to the Blockchain and may be issued a Certification ID. Thereafter, Device A may receive basic information on the Cloud from the Mediator. Device A may access the Cloud based on the corresponding information and may, then, perform a process of negotiating a cipher suite during a TLS Handshake. When a TLS channel is established, the Device may transmit basic Resources to a Resource Directory of the Cloud. And, the basic resources may be stored in the Cloud. Later on, the corresponding information may be used for performing communication between devices through the Cloud.

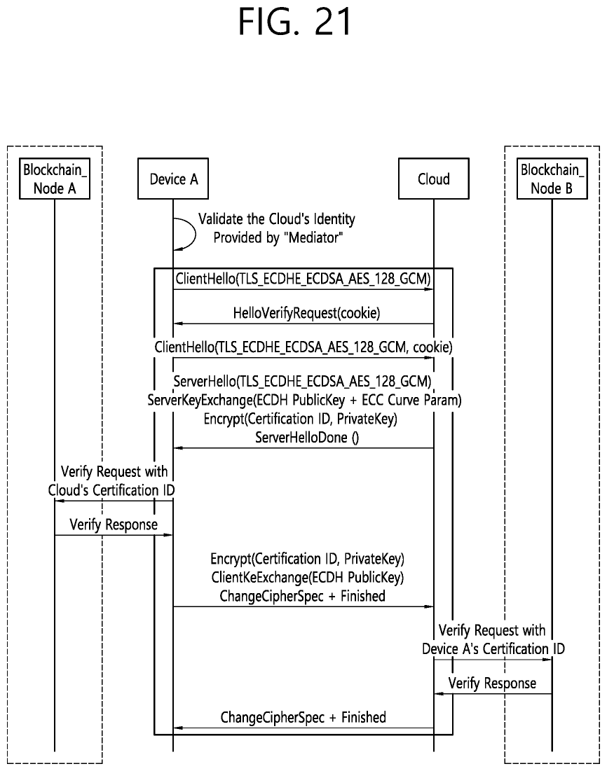

FIG. 21 is a diagram showing an embodiment of a TLS Handshake method between a Device and a Cloud applying the Blockchain principle.

Referring to FIG. 21, Device A may perform TLS Handshake with the Cloud. Device A may firstly verify whether the Cloud is reliable, based on the information on the Cloud, which is transmitted from the Mediator. Once the verification is successfully completed, Device A may attempt to perform TLS Handshake by sending, to the Cloud, a ClientHello message including a supported cipher suite. At this point, a cipher suite that is based on the certificate (e.g., TLS_ECDHE_ECHSA_WITH_AES_128_GCM) shall be used as the cipher suite, which is currently being used. The Cloud may send a response to Device A by sending a ServerHello message and a ServerKeyExchange message for public key exchange. At this point, a Certification ID, which means the certificate (or credential) information of Device B within the Blockchain, may be encrypted to a private key, which is transmitted along with the messages. Device A may use the corresponding value in order to verify the authentication information of the Cloud from the Blockchain. The same method may be performed when Device A authenticates Device B. Device A may transmit, to Device B, a result of encrypting a ClientKeyExchange message and a Certification ID (value of attribute “blockchaincertid” of “oic/sec/cred”), which means the credential (or certificate) information of Device A within the Blockchain, to a private key. The Cloud may verify the authentication information of Device A by accessing the Blockchain Node. When Device A and the Cloud have successfully completed the verification of the authentication information of their counterparts, a common (or shared) private key may be calculated by using the received public keys. Thereafter, the TLS Handshake may be ended.

4-6. IoT Business Model by Adding Information within a Blockchain

4-6-1. Data Collection

In order to develop more enhanced services, most of the manufacturers may collect data on the users' method of using electrical appliances based on a Cloud. The techniques of collecting, structuring, and reprocessing data are being developed in the Cloud for the data collection. However, the data collection technique, which is based on the corresponding Cloud, cannot access information on another device, which is manufactured by a different manufacturer. That is, only the information being provided from a device, which is manufactured by the same manufacturer, may be collected.

This has limitations in developing a new service for IoT devices belonging to an environment, which is associated with another device. In relation to this, the corresponding limitations may be overcome by establishing a Blockchain network to which manufacturers that have formed, in advance, a trusting relationship among one another, such as OCF. This is because a Blockchain has a special security feature of sharing information that ensures integrity to one another. Whenever needed, by carrying out a process of negotiating the information being registered to the Node, with the exception for sensitive information, information may be optionally shared.

4-6-2. Demand Response

In case of services related to monetary compensation (or rewards), such as Demand Response (DR), the presence of a system backing a trusting relationship between a service provider and a consumer (or user) is very important. Since the Blockchain is capable of ensuring integrity of the information shared among the Nodes, the Blockchain may be used for the purpose of collecting data and proving the credibility of the corresponding data. This is because the Blockchain can prove that the transaction history between users cannot be tampered. Accordingly, the Blockchain may be applied to DR services.

In case of an existing system, the service provider may provide rewards and/or compensation based on the expense history (or record) of a user, which is autonomously collected by the service provider. However, during this process, the consumer may question the reward and/or compensation provided by the supplier (or service provider). Therefore, the expense history (or record) of the corresponding user may be periodically (e.g., on a daily basis) stored in the Blockchain, which can be accessed by both the service provider and the consumer. Accordingly, the consumer is convinced and assured that the corresponding history (or record) is not configured of false information, and the service provider may secure legitimacy (or justification) for the rewards (and/or compensation).

4-6-3. Client Reward

One of the best advantages of the Blockchain is that information having ensured integrity can be safely shared among devices. Based on this advantage, it may be possible for two or more different service providers to integrate their services. A typical example of this case corresponds to a “Combine Points” service.

A number of service providers may establish, in advance, a trusting relationship among one another by contract. The corresponding companies may participate in a blockchain so as to open (or reveal) and share the consumers' points. By doing so, this allows the consumer to combine and use the points, which were/are rewarded for the consumer's purchase of one or more products of a specific company (or manufacturer), when purchasing consumable goods, electric appliances, and so on, of other companies (or manufacturers).

In case a consumer owns very few points to be used for purchasing a product, the consumer may have difficulty in using the corresponding reward points. However, if there exists an environment allowing reward points to be shared by multiple service providers, the consumer may be capable of combining the points that are rewarded from multiple manufacturers and use the points more advantageously. Thus, the consumer is given the opportunity to spend his/her reward points. If the consumer is guided to use his/her reward points through various special purchase events, this may have an advantageous effect for both the service provider(s) and the consumer(s).

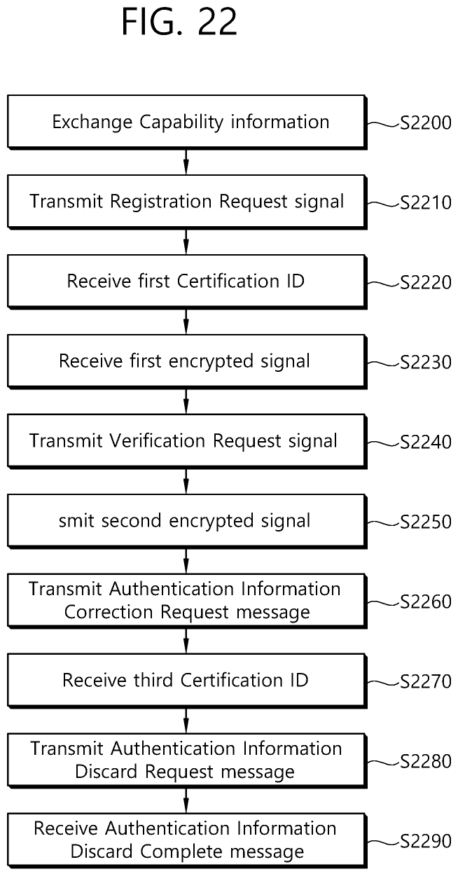

FIG. 22 is a flowchart showing an embodiment of an IoT device operation method.

Referring to FIG. 22, an IoT device may exchange Capability information (S2200). For example, an IoT device may exchange Capability information related to whether or not the IoT device can access a Blockchain Node with an OBT.

For example, in a Blockchain, a Block is stored in an entity that is referred to as a Node. And, such Nodes are connected to one another to create a network configuring a P2P format. In case of performing mutual authentication by using the Blockchain, two devices (e.g., the IoT device and the OBT) shall be capable of accessing the Node. The device shall be expressed through a new attribute “blockchain”, which indicates Access or Non-Access to a Blockchain Node (TRUE/FALSE). For example, in oic/sec/doxm of an OCF IoT device, if “blockchain”=TRUE, this may mean that the OCF IoT device is a Device capable of accessing a Blockchain Node.

An OBT requesting an initial authentication verifies the Capability of an authentication method (OTM) that is supported by the IoT device, by using a GET command (or instruction). At this point, in case the IoT device supports an authentication using the Blockchain, the IoT device includes the value 3 (Block Chain OTM), which indicates the corresponding Capability, and the IoT device may respond to a Blockchain enable parameter, which indicates accessibility to a Blockchain Node, as TRUE. In case the OBT sends a response indicating that it will attempt to perform authentication by using the blockchain, the IoT device selects and transmits the value 3 (Block Chain OTM), by using a POST command (or instruction). In relation to this, the IoT device may additionally verify the accessibility of a counterpart device to the Blockchain node by using the oic/sec/doxm resource.

The IoT device may transmit a registration request signal (S2210). For example, the IoT device may transmit, to a Blockchain Node, a registration request signal including a public key certificate of the IoT device and a universally unique identifier (UUID) of the IoT device.

For example, the public key may be a certificate being issued by a certification authority (CA).

For example, prior to carrying out the actual Onboarding process, devices that are to carry out Onboarding may transmit, to a Blockchain node, a public key certificate stored inside the corresponding device and information related to the public key certificate. After receiving the information, the node may register and store the corresponding certificate through a verification process among other nodes.

The IoT device may receive a first Certification ID (S2220). For example, the IoT device may receive, from the Blockchain Node, a first certification identifier (ID) for the IoT device. For example, the first Certification ID may be a newly generated block.

For example, the Node that has received the information of the device for the first time may generate and transmit a Certification ID being mapped to the information transmitted to the device by one-to-one (1:1) mapping. The device may store the Certification ID received from the Node in an internal resource. For example, in case of OCF, “blockchaincertid”, an attribute of an oic/sec/cred resource, which stores the information related to the credential of the Device, may be stored. Based on this value, another device may verify a certificate within the Blockchain during a future verification process.

The IoT device may receive a first encrypted signal (S2230). For example, the IoT device may receive a first encrypted signal from an onboarding tool (OBT). For example, the encrypted signal may include a second certification ID of the OBT and encrypted information being encrypted based on a private key of the OBT.

For example, in order to perform authentication between the IoT device and the OBT, the OBT may transmit, to the IoT device, a ServerHello message for cipher suite negotiation and a ServerKeyExchange message for public key exchange. At this point, the OBT may encrypt a Certification ID (a value of the attribute “blockchaincertid” of “oic/sec/cred”) indicating credential (or certificate) information within the Blockchain to a private key, which is then transmitted along with the messages.

The IoT device may transmit a verification request signal (S2240). For example, the IoT device may transmit, to the Blockchain Node, a verification request signal including the second certification ID of the OBT.

For example, the IoT device may verify the authentication information of the OBT within the Blockchain by using the received corresponding information.

The IoT device may transmit a second encrypted signal (S2250). For example, the IoT device may transmit a second encrypted signal to the OBT. For example, the second encrypted signal may include a first Certification ID of the IoT device and information being encrypted based on a private key of the IoT device.

For example, when the IoT device transmits, to the OBT, a ClientKeyExchange message for public key exchange, the IoT device may also transmit an encryption result of a Certification ID, which indicates the credential information of the IoT device within the blockchain, being encrypted to the private key along with the message. The OBT may verify the authentication information of the IoT device by accessing a corresponding Blockchain Node. When the IoT device and the OBT respectively verify that the certificates of their counterparts within the Blockchain are both “valid”, the two Devices may calculate a common private key based on each of the received public keys.

For example, the IoT device may transmit an authentication information correction request message (S2260). For example, the IoT device may transmit an authentication information correction request message to the Blockchain Node. For example, the authentication information correction request message may include a UUID of the IoT device.

For example, the public key authentication information of a Device being registered to the Blockchain may be initially registered by a subject of the corresponding information. Moreover, the actions of managing, updating, and discarding the authentication information may also be requested only by the subject of the corresponding information to ensure stability of security. When the Blockchain Node receives a request message, the Blockchain Node may request a Device UUID to be mandatorily included in the request message. By using the Device UUID, the Node may verify the subject of the authentication information, so as to request managing, updating, and discarding of the corresponding authentication information.

For example, the Device may request a correction of the authentication information, which was initially registered to the Blockchain Node. The IoT device may transmit, to Node A, a message including a Certification ID, a Device ID, and information that is to be requested for an update.

The IoT device may receive a third Certification ID (S2270). For example, the IoT device may receive a third Certification ID for the IoT device from the Blockchain Node. For example, the third Certification ID may be a newly generated block.

For example, after receiving the message, Node A may verify whether the Device UUID being included in the transmitted message and a Device UUID being stored in the authentication information of the corresponding Certification ID are the same. If the two Device UUIDs are the same (i.e., match), Node A may perform the task requested by the IoT device and may then share the new information with other nodes. Thereafter, by transmitting a Task complete (“Success”) message and a new Certification ID to the IoT device, the task of Node A may be ended. Whenever needed, the IoT device may encrypt a new Certification ID to a private key of the IoT device, which is then transmitted to Device OBT.

The IoT device may transmit an authentication information discard request message (S2280). For example, the IoT device may transmit an authentication information discard request message to the Blockchain Node. For example, the authentication information discard request message may include a UUID of the IoT device.

For example, the IoT device may transmit, to Node A, a discard request message including the Certification ID and the Device ID.

The IoT device may receive an authentication information discard complete message (S2290). For example, the IoT device may receive an authentication information discard complete message from the Blockchain Node.

After receiving the message, Node A may verify whether the Device UUID being included in the transmitted message and a Device UUID being stored in the authentication information of the corresponding Certification ID are the same. If the two Device UUIDs are the same (i.e., match), Node A may perform the discarding task requested by the IoT device and may then share the new information with other nodes. Thereafter, by transmitting a Task complete message to the IoT device, the task of Node A may be ended. Whenever needed, the IoT device may inform (or notify) the OBT that the initially shared Certification ID can no longer be used.

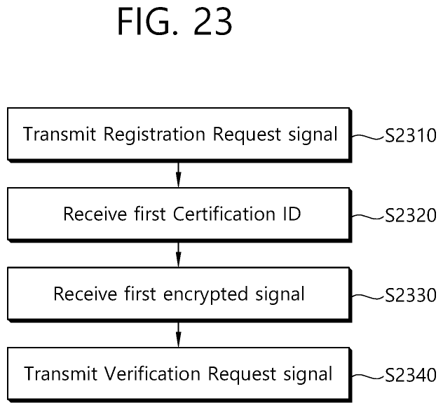

FIG. 23 is a flowchart showing an embodiment of an OBT operation method.

Referring to FIG. 23, an Onboarding tool (OBT) may transmit a registration request signal (S2310). For example, the OBT may transmit, to a Blockchain Node, a registration request signal including a public key certificate of the OBT and a universally unique identifier (UUID) of the OBT.

The OBT may receive a first Certification ID (S2320). For example, the OBT may receive, from the Blockchain Node, a first certification identifier (ID) for the OBT. For example, the first Certification ID may be a newly generated block.

The OBT may receive a first encrypted signal (S2330). For example, the OBT may receive a first encrypted signal from an Internet of Things (IoT) device. For example, the encrypted signal may include a second certification ID of the IoT device and encrypted information being encrypted based on a private key of the IoT device.

The OBT may transmit a verification request signal (S2340). For example, the OBT may transmit, to the Blockchain Node, a verification request signal including the second certification ID of the IoT device.

Among the detailed process steps indicated in the examples of FIG. 22 and FIG. 23, some steps may not be necessary steps and may, therefore, be omitted. Other process steps other than the process steps shown in FIG. 22 and FIG. 23 may be added, and the order of the process steps may also change. Among the process steps, some steps may have independent technical meanings.

The technical features of the above-described present specification may be applied to various apparatus (or devices) and methods. For example, the technical features of the above-described present specification may be performed/supported by the apparatus (or device.) For example, the technical features of the above-described present specification may be implemented based the processing chip, or may be implemented based on the processor and the memory, or may be implemented based on the processor and the memory. For example, an Internet of Things (IoT) device of the present specification may include a transceiver transmitting and receiving radio signals, and a processor being operatively connected to the transceiver. Herein, the processor may be configured to transmit, to a Blockchain Node, a registration request signal including a public key certificate of the IoT device and a universally unique identifier (UUID) of the IoT device, to receive, from the Blockchain Node, a first certification identifier (ID) for the IoT device, wherein the first Certification ID is a newly generated block, to receive a first encrypted signal from an onboarding tool (OBT), wherein the encrypted signal includes a second certification ID of the OBT and encrypted information being encrypted based on a private key of the OBT, and to transmit, to the Blockchain Node, a verification request signal including the second certification ID of the OBT.

The technical features of the above-described present specification may be implemented based on a computer readable medium (CRM). For example, the CRM that is proposed in the present specification, which is at least one computer readable medium including an instruction being executed by at least one processor in a wireless local area network (WLAN) system, may include an instruction performing an operation including the steps of transmitting, to a Blockchain Node, a registration request signal including a public key certificate of the IoT device and a universally unique identifier (UUID) of the IoT device, receiving, from the Blockchain Node, a first certification identifier (ID) for the IoT device, wherein the first Certification ID is a newly generated block, receiving a first encrypted signal from an onboarding tool (OBT), wherein the encrypted signal includes a second certification ID of the OBT and encrypted information being encrypted based on a private key of the OBT, and transmitting, to the Blockchain Node, a verification request signal including the second certification ID of the OBT.

An instruction being stored in a CRM of the present specification may be executed by at least one processor. The at least one processor related to the CRM of the present specification may be the processor or the processing chip, or the processor. Meanwhile, the CRM of the present specification may be the memory or the memory, or a separate external memory/storage medium/disc, and so on.

The foregoing technical features of this specification are applicable to various applications or business models. For example, the foregoing technical features may be applied for wireless communication of a device supporting artificial intelligence (AI).

Artificial intelligence refers to a field of study on artificial intelligence or methodologies for creating artificial intelligence, and machine learning refers to a field of study on methodologies for defining and solving various issues in the area of artificial intelligence. Machine learning is also defined as an algorithm for improving the performance of an operation through steady experiences of the operation.

An artificial neural network (ANN) is a model used in machine learning and may refer to an overall problem-solving model that includes artificial neurons (nodes) forming a network by combining synapses. The artificial neural network may be defined by a pattern of connection between neurons of different layers, a learning process of updating a model parameter, and an activation function generating an output value.

The artificial neural network may include an input layer, an output layer, and optionally one or more hidden layers. Each layer includes one or more neurons, and the artificial neural network may include synapses that connect neurons. In the artificial neural network, each neuron may output a function value of an activation function of input signals input through a synapse, weights, and deviations.

A model parameter refers to a parameter determined through learning and includes a weight of synapse connection and a deviation of a neuron. A hyper-parameter refers to a parameter to be set before learning in a machine learning algorithm and includes a learning rate, the number of iterations, a mini-batch size, and an initialization function.

Learning an artificial neural network may be intended to determine a model parameter for minimizing a loss function. The loss function may be used as an index for determining an optimal model parameter in a process of learning the artificial neural network.

Machine learning may be classified into supervised learning, unsupervised learning, and reinforcement learning.

Supervised learning refers to a method of training an artificial neural network with a label given for training data, wherein the label may indicate a correct answer (or result value) that the artificial neural network needs to infer when the training data is input to the artificial neural network. Unsupervised learning may refer to a method of training an artificial neural network without a label given for training data. Reinforcement learning may refer to a training method for training an agent defined in an environment to choose an action or a sequence of actions to maximize a cumulative reward in each state.

Machine learning implemented with a deep neural network (DNN) including a plurality of hidden layers among artificial neural networks is referred to as deep learning, and deep learning is part of machine learning. Hereinafter, machine learning is construed as including deep learning.

The foregoing technical features may be applied to wireless communication of a robot.

Robots may refer to machinery that automatically process or operate a given task with own ability thereof. In particular, a robot having a function of recognizing an environment and autonomously making a judgment to perform an operation may be referred to as an intelligent robot.

Robots may be classified into industrial, medical, household, military robots and the like according uses or fields. A robot may include an actuator or a driver including a motor to perform various physical operations, such as moving a robot joint. In addition, a movable robot may include a wheel, a brake, a propeller, and the like in a driver to run on the ground or fly in the air through the driver.

The foregoing technical features may be applied to a device supporting extended reality.

Extended reality collectively refers to virtual reality (VR), augmented reality (AR), and mixed reality (MR). VR technology is a computer graphic technology of providing a real-world object and background only in a CG image, AR technology is a computer graphic technology of providing a virtual CG image on a real object image, and MR technology is a computer graphic technology of providing virtual objects mixed and combined with the real world.

MR technology is similar to AR technology in that a real object and a virtual object are displayed together. However, a virtual object is used as a supplement to a real object in AR technology, whereas a virtual object and a real object are used as equal statuses in MR technology.

XR technology may be applied to a head-mount display (HMD), a head-up display (HUD), a mobile phone, a tablet PC, a laptop computer, a desktop computer, a TV, digital signage, and the like. A device to which XR technology is applied may be referred to as an XR device.

The claims specified in the present specification may be combined by various methods. For example, technical features of the method claim(s) of the present specification may be combined so as to be implemented as a device (or apparatus), and technical features of the device claim(s) may be combined so as to be implemented as a method. Additionally, technical features of the method claim(s) of the present specification and technical features of the device claim(s) may be combined so as to be implemented as a device (or apparatus), and technical features of the method claim(s) of the present specification and technical features of the device claim(s) may be combined so as to be implemented as a method.

What is claimed is:

1. A method performed by an Internet of Things (IoT) device, the method comprising:
transmitting, to a Blockchain Node, a registration request signal including a public key certificate of the IoT device and a universally unique identifier (UUID) of the IoT device;
receiving, from the Blockchain Node, a first certification identifier (ID) for the IoT device, wherein the first Certification ID is a newly generated block;
receiving a first encrypted signal from an onboarding tool (OBT), wherein the encrypted signal includes a second certification ID of the OBT and encrypted information being encrypted based on a private key of the OBT; and
transmitting, to the Blockchain Node, a verification request signal including the second certification ID of the OBT.

2. The method of claim 1, wherein the public key certificate is a certificate issued by a Certification Authority (CA).

3. The method of claim 1, further comprising:
transmitting a second encrypted signal to the OBT, wherein the second encrypted signal includes a first Certification ID of the IoT device and information being encrypted based on a private key of the IoT device.

4. The method of claim 1, further comprising:
exchanging Capability information being related to whether or not the IoT device is capable of accessing a Blockchain Node with an OBT.

5. The method of claim 1, further comprising:
transmitting an authentication information correction request message to the Blockchain Node, wherein the authentication information correction request message includes a UUID of the IoT device; and
receiving a third Certification ID for the IoT device from the Blockchain Node, wherein the third Certification ID is a newly generated block.

6. The method of claim 1, further comprising:
transmitting an authentication information discard request message to the Blockchain Node, wherein the authentication information discard request message includes a UUID of the IoT device; and
receiving an authentication information discard complete message from the Blockchain Node.

7. An Internet of Things (IoT) device, comprising:
a transceiver transmitting and receiving radio signals; and
a processor being operatively connected to the transceiver,
wherein the processor is configured to:
transmit, to a Blockchain Node, a registration request signal including a public key certificate of the IoT device and a universally unique identifier (UUID) of the IoT device,
receive, from the Blockchain Node, a first certification identifier (ID) for the IoT device, wherein the first Certification ID is a newly generated block,
receive a first encrypted signal from an onboarding tool (OBT), wherein the encrypted signal includes a second certification ID of the OBT and encrypted information being encrypted based on a private key of the OBT, and
transmit, to the Blockchain Node, a verification request signal including the second certification ID of the OBT.

8. The IoT device of claim 7, wherein the public key certificate is a certificate issued by a Certification Authority (CA).

9. The IoT device of claim 7, wherein the processor is further configured to:
transmit a second encrypted signal to the OBT, wherein the second encrypted signal includes a first Certification ID of the IoT device and information being encrypted based on a private key of the IoT device.

10. The IoT device of claim 7, wherein the processor is further configured to:
exchange Capability information being related to whether or not the IoT device is capable of accessing a Blockchain Node with an OBT.

11. The IoT device of claim 7, wherein the processor is further configured to:
transmit an authentication information correction request message to the Blockchain Node, wherein the authentication information correction request message includes a UUID of the IoT device; and
receive a third Certification ID for the IoT device from the Blockchain Node, wherein the third Certification ID is a newly generated block.

12. The IoT device of claim 7, wherein the processor is further configured to:
transmit an authentication information discard request message to the Blockchain Node, wherein the authentication information discard request message includes a UUID of the IoT device, and
receive an authentication information discard complete message from the Blockchain Node.

13. An onboarding tool (OBT), comprising:
a transceiver transmitting and receiving radio signals; and
a processor being operatively connected to the transceiver,
wherein the processor is configured to:
transmit, to a Blockchain Node, a registration request signal including a public key certificate of the OBT and a universally unique identifier (UUID) of the OBT,
receive, from the Blockchain Node, a first certification identifier (ID) for the OBT, wherein the first Certification ID is a newly generated block,
receive a first encrypted signal from an Internet of Things (IoT) device, wherein the encrypted signal includes a second certification ID of the IoT device and encrypted information being encrypted based on a private key of the IoT device, and
transmit, to the Blockchain Node, a verification request signal including the second certification ID of the IoT device.
